(19) United States
(12) Patent Application Publication
(10) Pub. No.: US 2017/0098433 A1
(43) Pub. Date: Apr. 6, 2017

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventors: Wataru Suzuki, Tokorozawa-shi (JP); Shinya Takeichi, Kawasaki-shi (JP)

(21) Appl. No.: 15/283,947

(22) Filed: Oct. 3, 2016

(30) Foreign Application Priority Data
Oct. 5, 2015 (JP) 2015-197791

(51) Int. Cl. G09G 5/24; G09G 5/26; G09G 5/32; G06T 11/60

(52) U.S. Cl. CPC G09G 5/243; G06T 11/60; G09G 5/26; G09G 5/32

(57) ABSTRACT

A limited display area can be effectively used for character display. According to one embodiment, an information processing apparatus includes a derivation unit configured to derive a length by which a position of a head character laid out at a beginning of a line or column of characters displayed in a display area of a display unit can be changed within a range in which a letter form of the head character does not exceed the display area, and an adjustment unit configured to adjust the layout position of the head character and that of a character subsequent to the head character based on the length.

### BACKGROUND OF THE INVENTION

Field of the Invention

The present invention relates to an information processing apparatus, an information processing method, and a program.

Description of the Related Art

Mobile computers such as a smartphone and a tablet terminal are further advancing, and wearable computers such as a head mounted display and a watch are becoming widespread. As devices themselves are miniaturized, device display units are also becoming smaller. Many devices even with such a small display unit often display a character string on the display unit, using the display unit as a user interface. Display units, as typified by a watch, are no longer limited to a rectangular shape. Japanese Patent Application Laid-Open No. 2011-248575 discusses a technique for label printing on a portable medium of circular shape, for example. According to the technique, an upper reference position and a lower reference position for character layout are provided in a printing area. If an upper portion of an area available for layout lies above the upper reference position, the upper portion is shifted to below the upper reference position. If a lower portion of the area available for layout lies below the lower reference position, the lower portion is shifted to above the lower reference position.

According to the conventional technique, if a character string is displayed as though it were poured into a display area of a device, whether a character exceeds the display area is determined based on a rectangular character area determined by a feed width of the character string and a height (character size) of the character. While the determined character area is rectangular, the display area is not necessarily limited to a rectangular shape. Therefore, it can be determined that a character runs over the display area even if a letter form of the character fits in the display area. There has thus been a problem in that the limited display area cannot be efficiently used.

### SUMMARY OF THE INVENTION

Aspects of the present invention are directed to effectively using a limited display area for character display.

According to an aspect of the present invention, an information processing apparatus includes a derivation unit configured to derive a length by which a position of a head character laid out at a beginning of a line or column of characters displayed in a display area of a display unit can be changed within a range in which a letter form of the head character does not exceed the display area, and an adjustment unit configured to adjust the layout position of the head character and that of a character subsequent to the head character based on the length.

Further features of the present invention will become apparent from the following description of exemplary embodiments with reference to the attached drawings.

### BRIEF DESCRIPTION OF THE DRAWINGS

FIG. 1 is a diagram illustrating an example of a hardware configuration of an information processing apparatus.

FIG. 2 is a diagram illustrating an example of a software configuration of the information processing apparatus.

FIG. 3 is a flowchart illustrating an example of information processing according to a first exemplary embodiment.

FIG. 4 is a diagram illustrating an example of a method for determining a layout position of a first character of a character string.

FIG. 5 is a diagram illustrating metrics information about a character.

FIGS. 6A to 6D are diagrams illustrating an example of processing when it is determined that a character area does not fit in a display area.

FIGS. 7A and 7B are diagrams for describing definitions of character-related areas other than a character area.

FIGS. 8A to 8D are diagrams illustrating other examples of patterns for dividing a character area and occupation areas.

FIG. 9 is a flowchart illustrating an example of a determination method of an occupation area determination unit.

FIGS. 10A, 10B, and 10C are diagrams for describing processing for fitting an end-of-line character into a display area.

FIG. 11 is a flowchart illustrating an example of information processing according to a second exemplary embodiment.

FIGS. 12A to 12D are diagrams illustrating examples where characters are laid out in a circular display area.

FIG. 13 is a diagram illustrating an example of a method for calculating a width X which is movable to the left.

FIGS. 14A to 14D are diagrams illustrating processing for switching shapes of a display area.

FIG. 15 is a flowchart illustrating an example of information processing according to a third exemplary embodiment.

FIG. 16 is a flowchart illustrating an example of information processing according to a fourth exemplary embodiment.

FIG. 17 is a flowchart illustrating an example of the information processing apparatus according to the second exemplary embodiment.

### DESCRIPTION OF THE EMBODIMENTS

Exemplary embodiments of the present invention will be described below with reference to the drawings.

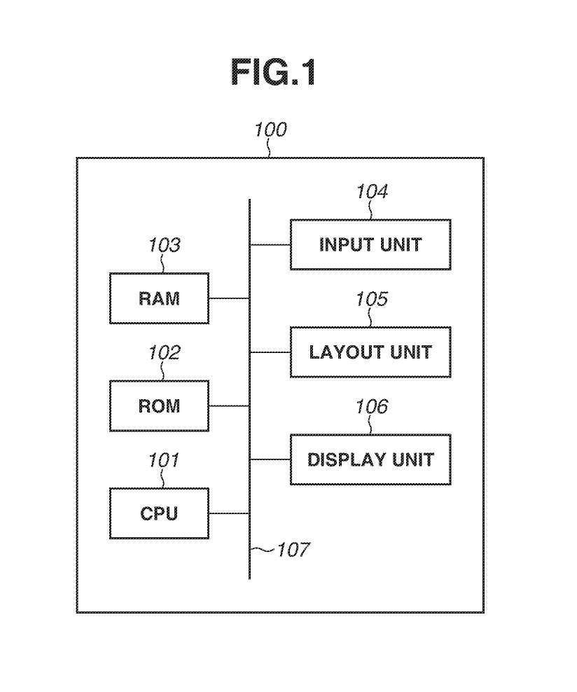

A configuration of an information processing apparatus 100 according to the present exemplary embodiment will be described with reference to FIG. 1. A central processing unit (CPU) 101 is a system control unit and controls the entire information processing apparatus 100. A read-only memory (ROM) 102 is a read-only memory storing programs and parameters that do not need to be changed and table information to be described below. A random access memory (RAM) 103 is a rewritable memory temporarily storing programs and data supplied from an external apparatus. An input unit 104 receives inputs from a user. A mouse, a keyboard, a touch panel, and/or a voice-receiving microphone are the input unit 104. A layout unit 105 obtains character string information stored in the ROM 102 and/or the RAM 103 or received by the input unit 104, and performs processing for laying out a character string in a display area. The display unit 106 displays rendered characters as graphics or a user interface according to a layout position of the character string determined by the layout unit 105. A system bus 107 connects the units 101 to 106 in a communicable manner.

The CPU 101 executes processing based on the programs stored in the ROM 102 to implement a software configuration of the information processing apparatus 100 and processing of flowcharts to be described below.

Storage media for supplying the programs to the foregoing configuration, aside from the ROM 102, will be described. For example, a flexible disk, a hard disk, an optical disk, a magneto-optical disk, a compact disc read-only memory (CD-ROM), a compact disk-recordable (CD-R), a magnetic tape, a memory card, and/or a digital versatile disc (DVD) may be added to the configuration of the information processing apparatus 100 according to the present exemplary embodiment.

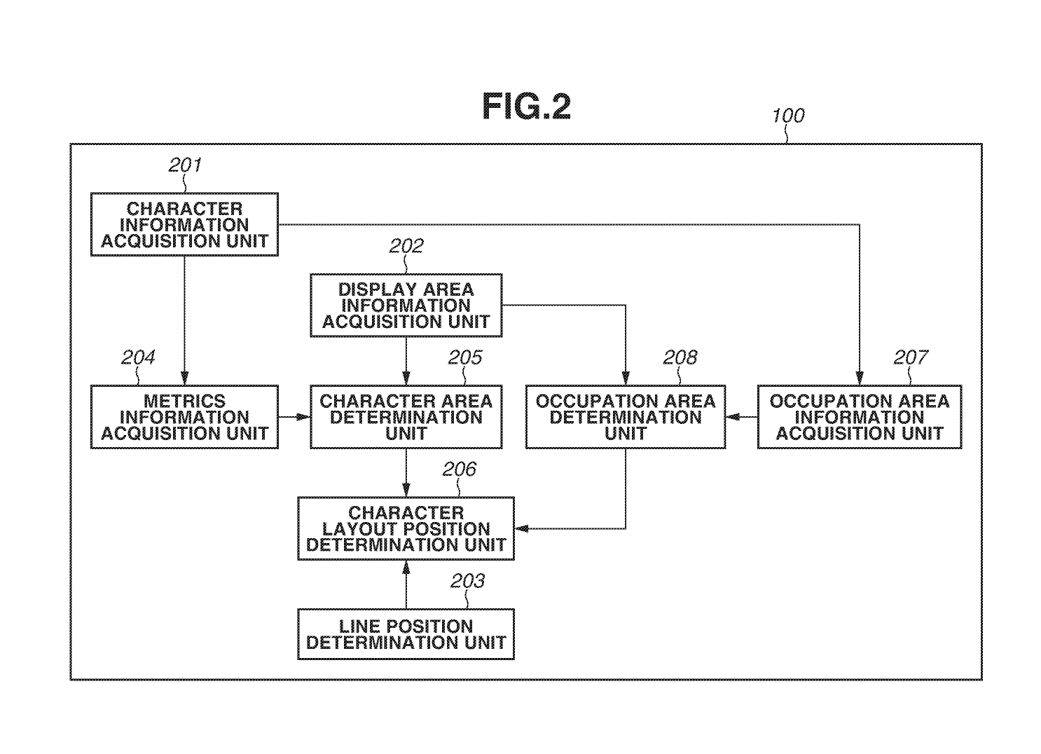

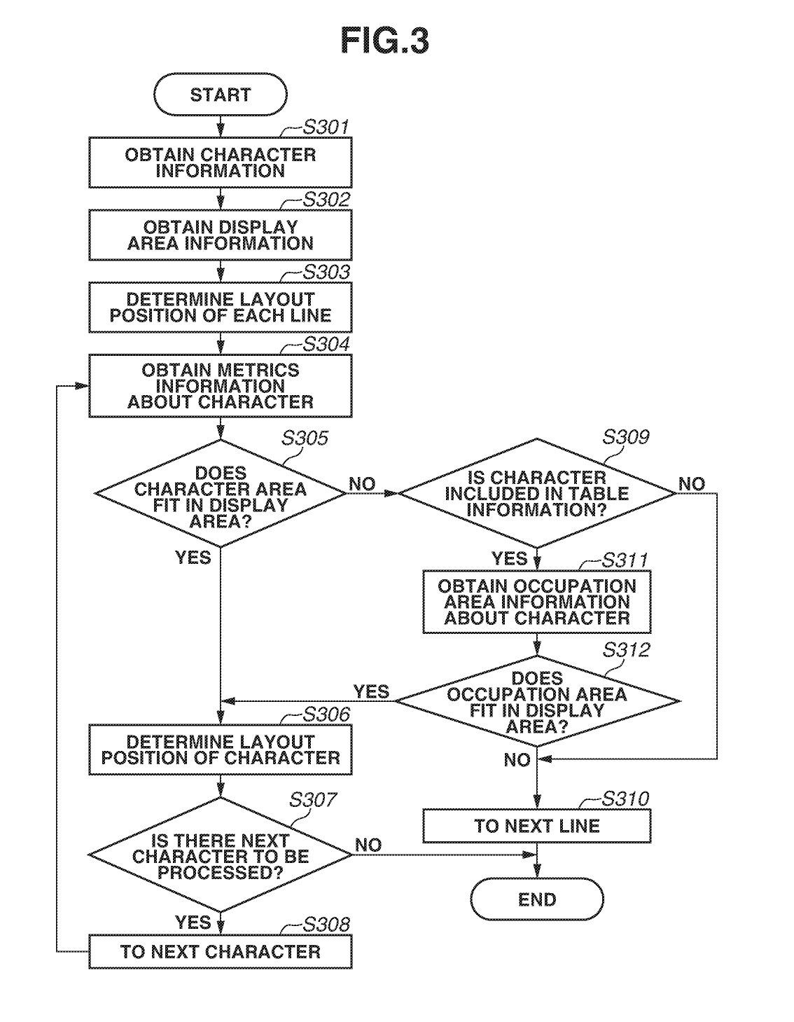

In a first exemplary embodiment, an example of character layout processing with respect to an end-of-line character near a boundary of a display area when a character string is displayed as though it were poured into the display unit 106 of circular shape will be described with reference to the drawings. FIG. 2 is a diagram illustrating an example of the software configuration of the information processing apparatus 100. FIG. 3 is a flowchart illustrating an example of information processing of the information processing apparatus 100. The arrows in the software configuration of FIG. 2 indicate examples of information exchange. The information exchange is not limited to the arrows of FIG. 2.

In step S301, a character information acquisition unit 201 obtains character information to be displayed in the display area. As employed herein, the character information is assumed to be stored in the ROM 102 or the RAM 103. However, input data received from the user by the input unit 104 may also include character information, which the character information acquisition unit 201 may obtain for display.

In step S302, a display area information acquisition unit 202 obtains display area information which is shape information about the display unit 106. The display area information acquisition unit 202 can obtain the display area information from the ROM 102 or the RAM 103. In the present exemplary embodiment, a circular shape is assumed. The display area information obtained by the display area information acquisition unit 202 includes center coordinates and a radius of the circle with the top left as an origin. However, the display area does not need to have a circular shape. The display area may be an arbitrary closed convex area, and the display area information acquisition unit 202 may obtain path information defining the shape. A closed convex area refers to an area having the shape defined by a closed path and a line segment connecting any two points inside the closed area is included in the area.

In step S303, a line position determination unit 203 determines a layout position of each line when the character string (character information) is poured into the display area, based on the premise that a predetermined font size is unchanged.

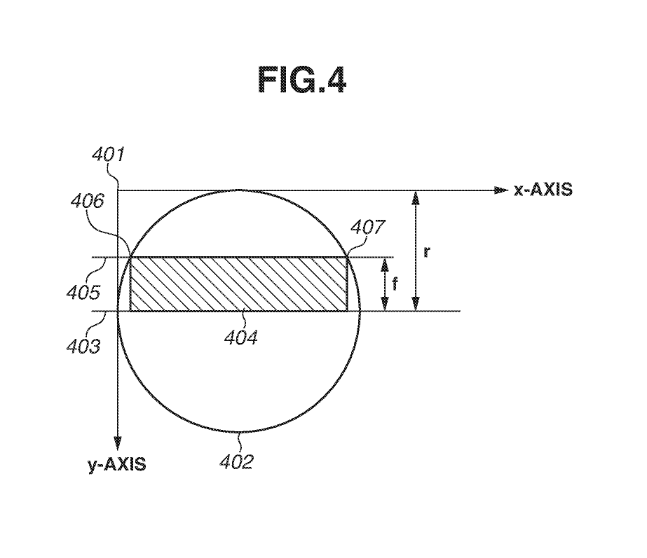

An example of a method for determining the layout position of the first character in the display area of circular shape will be described with reference to FIG. 4. FIG. 4 is a diagram illustrating a state where a circle 402 having a radius of r which indicates the display area, is arranged being tangent to an x-axis and a y-axis with an origin 401 at the top left. To display a string of more characters horizontally from the left, a horizontally wide portion of the circle can be desirably used. The line position determination unit 203 then determines the layout positions of lines so that rectangular areas for displaying the respective lines are allocated with reference to a straight line 403 represented by y=r. Assume that a font size f for display is the line height, in the upper semicircular portion of the circle 402, a rectangular area for each line is determined, with the intersections of the circle 402 and a straight line represented by y=r−nf (n is a natural number) as vertexes. A rectangle 404 is the display area of a line determined for n=1. The rectangle 404 is a rectangle that has a height of f and is included within the circle 402, with intersections 406 and 407 of the circle 402 and a straight line 405 represented by y=r−f as vertexes. In the lower semicircular portion of the circle 402, a rectangular area for each line has a height of f and is included in the circle 402, with the intersections of the circle 402 and a straight line represented by y=r+nf as vertexes. The method for determining line positions in a closed convex area that is the display area is not limited thereto.

In step S304, a metrics information acquisition unit 204 obtains metrics information about a character obtained by the character information acquisition unit 201. To lay out and display the character, the metric information includes at least shape information about the character, and information about a feed width of the character. The metrics information acquisition unit 204 is assumed to obtain the metrics information from font data stored in the ROM 102 or an external storage unit. The stored font data may be either an outline font or a bitmap font.

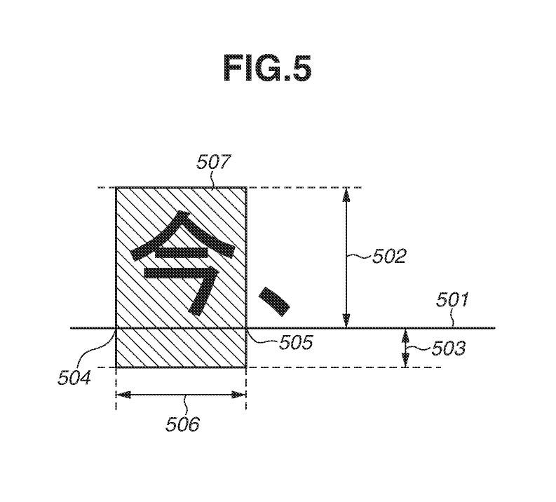

The metrics information about a character will be described with reference to FIG. 5. A letter form of a character is usually designed between an ascending height 502 above a base line 501 and a descending height 503 below the base line 501 serving as references of a vertical layout position. In the case of outline fonts, the letter form is expanded or contracted when displayed on the display unit 106 so that the sum of the ascending height 502 and the descending height 503 coincides with the font size f. The width from a letter form origin 504 of a character “ [symbol] ” and a letter form origin 505 of the next character “, ” is a character feed width 506 of the character “ [symbol] ”. Such metrics information is stored in the font data. Characters of the same font data have the same ascending height and the same descending height. However, the character feed width may differ depending on a character. In proportional fonts, the value of the character feed width varies character by character. In the present exemplary embodiment, a hatched rectangular area 507 expressed by the character feed width, the ascending height, and the descending height will be referred to as a character area. The head character of a line is laid out so that the top left of the character area coincides with the top left of the display area of the line indicated by the rectangle 404 of FIG. 4.

In step S305, a character area determination unit 205 determines character by character whether the character area obtained by the metrics information acquisition unit 204 fits in the display area obtained by the display area information acquisition unit 202. If the character area determination unit 205 determines that the character area fits in the display area (YES in step S305), the processing proceeds to step S306.

In step S306, a character layout position determination unit 206 determines the layout position of the character.

In step S307, the character layout position determination unit 206 determines whether there is a next character to be processed. If there is no next character (NO in step S307), that is, all the characters have been displayed by this line, then the processing of the flowchart illustrated in FIG. 3 ends. If there is a next character (YES in step S307), then the character layout position determination unit 206 moves the current position to the right by the character feed width. The processing proceeds to step S308.

In step S308, the character layout position determination unit 206 assumes the next character to be the character to be processed. The processing proceeds to step S304.

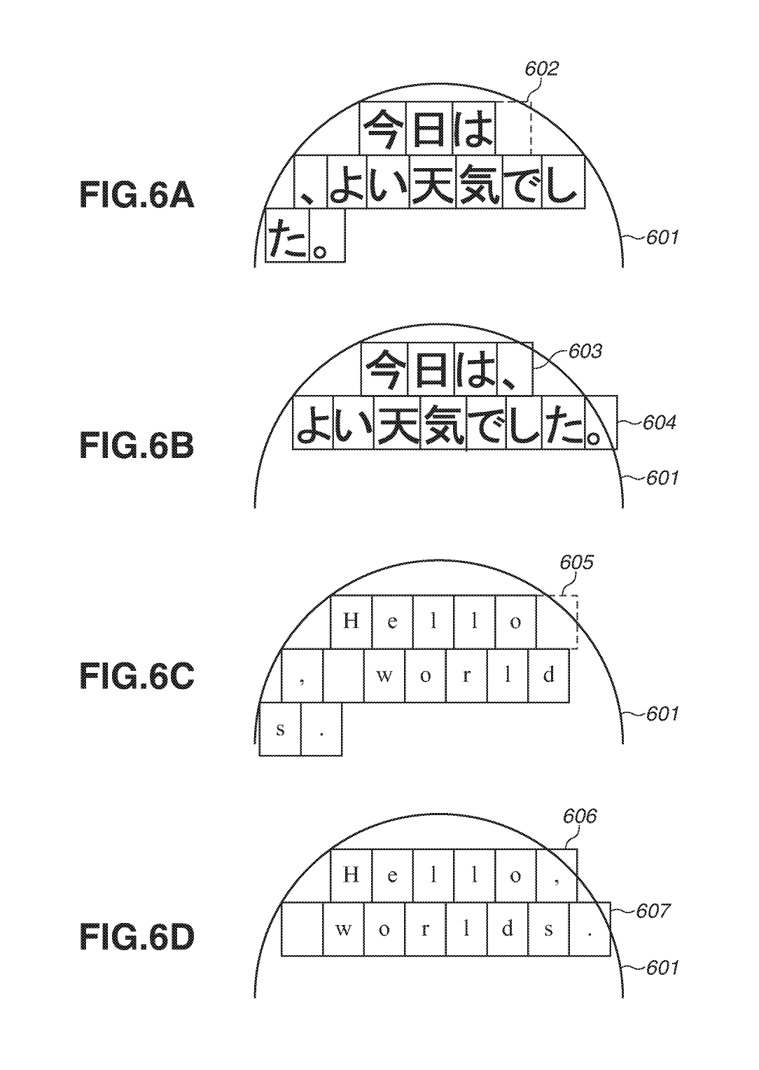

A case where the character area determination unit 205 determines in step S305 that the character area does not fit in the display area will be described with reference to FIGS. 6A to 6D. In FIGS. 6A to 6D, a circle 601 represents the display area of circular shape obtained by the display area information acquisition unit 202. The line position determination unit 203 determines the layout positions of the lines according to the method described in FIG. 4. The character area determination unit 205 then lays out a character string “ [symbol] [symbol] ” obtained by the character information acquisition unit 201 as if the character string is poured in from the upper portion of the circle 601. FIG. 6A illustrates the layout of the character string when it is determined based on the character areas whether the characters fit in the circle 601. The end-of-line character of the first line is “ [symbol] ”. A punctuation mark “, ” is laid out in the next line after a line break. A rectangle 602 represents the character area of the punctuation mark if the punctuation mark “, ” is laid out there. According to the conventional technique, the rectangle 602 exceeds the circle 601 in the top right portion and therefore the character associated with rectangle 602 is determined to not fit in the display area on the same line as the preceding character(s). However, the rectangle 602 runs over the boundary of the circle only in the top right portion of the circle, and the letter form of the punctuation mark fits in the circle 601 if only a size of the letter form “, ” is considered. FIG. 6B illustrates such a state. Although a rectangle 603 representing the character area of the punctuation mark exceeds the circle 601, the letter form of the punctuation mark fits in the circle 601, and is thus laid out at the end of the same line as the preceding character(s). Since the punctuation mark is laid out in this same line, the layout positions of the characters in the next line are changed. A rectangle 604 representing the character area of a punctuation mark “_{∘}” at the end of the second line also exceeds the circle 601. However, the letter form itself of the punctuation mark fits inside the circle, and when the punctuation mark “_{∘}” is left at the end of the second line, the entire character string thus fits within two lines.

FIG. 6C illustrates the layout of a character string if the character string obtained by the character information acquisition unit 201 is shown in alphabet letters of the English language. Using conventional techniques, the end-of-line character in the first line is “o”. The next character—a comma “,”—is laid out in the next line after a line break. A rectangle 605 illustrated by dotted lines represents the character area if the comma “,” is laid out in the first line. The rectangle 605 runs over the boundary for the circle 601 only in the top right portion of the circle, and the letter form itself of the comma “,” fits in the circle 601 if only a size of the letter form of “,” is considered. FIG. 6D illustrates such a state. Although a rectangle 606 representing the character area of the comma exceeds the circle 601, the letter form of the comma fits in the circle 601, and the comma “,” is laid out at the end of the first line. Since the comma is laid out in this first line, the layout positions of the characters in the next line are changed. A rectangle 607 representing the character area of the period “.” at the end also exceeds the boundary of the circle 601, but the letter form itself of the period “.” fits in the display area of the circle 601. Characters with small letter forms, such as a punctuation mark, a period, or a symbol, may be laid out near the right boundary of the non-rectangular display area such as the circle 601, without impairing the user's ability to view the character string even if the rectangular character areas of the characters do not fit in the display area. While in step S305 of the present exemplary embodiment the character area determination unit 205 determines whether the character area fits in the display area, the character area determination unit 205 may determine whether the character area overlaps the boundary line of the display area. If the character is in a bitmap font, the character area determination unit 205 may determine whether the character area overlaps the boundary line of the display area in units of pixels. The same applies to second and subsequent exemplary embodiments.

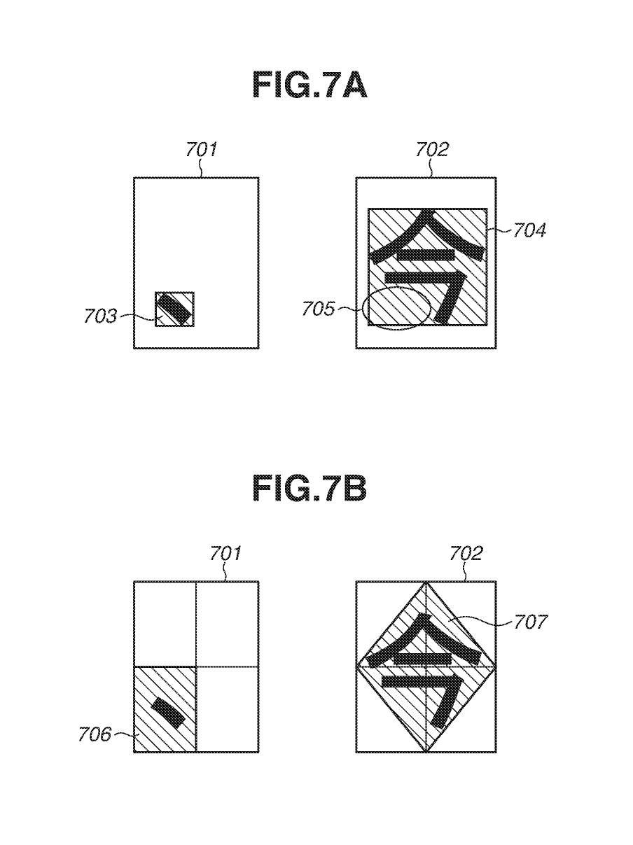

FIGS. 7A and 7B are diagrams for describing definitions of character-related areas used in the present exemplary embodiment aside from the character area. In FIG. 7A, a rectangle 701 and a rectangle 702 are representing the character areas of characters “, ” and “ [symbol] ”, respectively. As described above, the rectangles 701 and 702 are formed according to the feed width and font size (line height) of the characters. In many typical character display devices, whether characters fit in a display area is determined with reference to their character areas. A hatched area 703 and a hatched area 704 represent minimum rectangular areas including the respective letter forms. As compared to the character areas, with the minimum inclusive rectangular areas of the letter forms, whether the letters run over the boundaries of the display area can be more accurately determined. However, the inclusive rectangular areas are also constituted by horizontal and vertical sides. As illustrated by a frame 705, some characters may have many areas lacking letter forms within their inclusive rectangular area. In FIG. 7B, character areas are divided into a tile-like pattern, and a sum set of portions where there is a letter form among the divided areas is illustrated by oblique lines. Occupation areas 706 and 707 are respectively sum sets of areas where portions of the letter forms of the characters “, ” and “ [symbol] ” are located among the divided areas. Occupation areas are less strict compared with the inclusive rectangular areas, but can extract portions closer to a feature of the letter form of some characters such as “ [symbol] ”. In the present exemplary embodiment, an occupation area is defined as a sum set of divided areas where there is a portion of a letter form when a character area is divided into a predetermined pattern. However, a minimum rectangular area including a letter form as described above may be used as an occupation area.

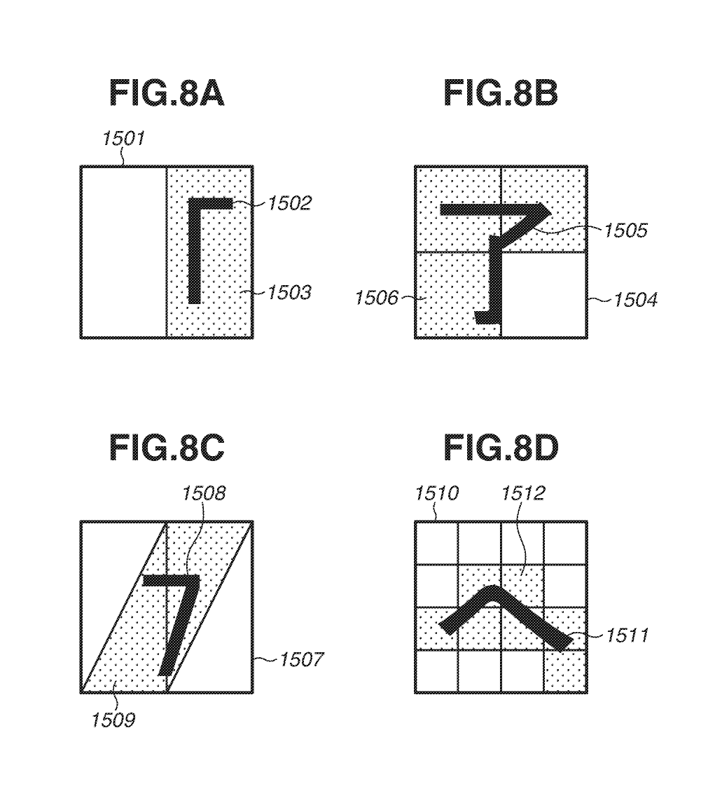

FIG. 7B illustrates an example where a character area is divided into four by a rectangular tile-like pattern and an example where a character area is divided into eight by a triangular tile-like pattern. The divisional shape and the number of divisions are not limited thereto. FIGS. 8A to 8D illustrate other examples of the dividing patterns of a character area and occupation areas. It is desirable that the divisional shape pattern includes a predetermined shape or shapes, and a simple and identical shape. As will be described below, various dividing patterns and various numbers can be used in dividing the character area. However, it is desirable that all characters displayed in the display area are divided by the same dividing pattern. In FIG. 8A, a character area 1501 of an “opening parenthesis” is vertically divided into two. The right area including a letter form 1502 serves as an occupation area 1503. In FIG. 8B, a character area 1504 of “ [symbol] ” is both vertically and horizontally divided into two and a sum set of the shaded areas including a letter form 1505 serves as an occupation area 1506. In FIG. 8C, a character area 1507 of “7” is divided into four triangles and the sum set of the shaded areas including a letter form 1508 serves as an occupation area 1509. In FIG. 8D, a character area 1510 of a character “ [symbol] ” is both vertically and horizontally divided by four into a total of 16 rectangular areas and the sum set of the shaded areas including a letter form 1511 serves as an occupation area 1512.

As illustrated in FIGS. 7B and 8A to 8D, if an occupation area is defined as a sum set of divided areas where there is a portion of a letter form among ones divided by a predetermined pattern, occupation area information about characters may be stored in advance as table information aside from the font data. In the present exemplary embodiment, it is assumed that a simplified dividing pattern is used, and occupation area information about characters of which letter forms are included only in part of the respective characteristic areas, like Japanese punctuation marks, are stored in table information.

If the character area determination unit 205 determines that the character area overlaps the boundary line of the display area (NO in step S305), the processing proceeds to step S309.

In step S309, the character area determination unit 205 determines whether the character is included in the table information. If it is determined that the character is not included in the table information (NO in step S309), the processing proceeds to step S310. Characters included in the table information are an example of a specific character.

In step S310, the character layout position determination unit 206 shifts the current position to the next line, ending the processing of the line so far.

If the character area determination unit 205 determines that the character is included in the table information (YES in step S309), the processing proceeds to step S311.

In step S311, an occupation area information acquisition unit 207 obtains the occupation area information about the character described in FIGS. 7A and 7B.

In step S312, an occupation area determination unit 208 determines whether the obtained occupation area fits in the display area. An example of the determination method will be described below. If the occupation area determination unit 208 determines that the occupation area fits in the display area (YES in step S312), the processing proceeds to step S306. If not (NO in step S312), the processing proceeds to step S310. In other words, if the CPU 101 determines that the occupation area fits in the display area, the CPU 101 determines that the layout position of the process target character comes at a rear position in the same line or column, after the character immediately previous to the process target character. On the other hand, if the CPU 101 determines that the occupation area does not fit in the display area, the CPU 101 determines the layout position of the process target character is to be placed in a line or column different from the character immediately previous to the process target character.

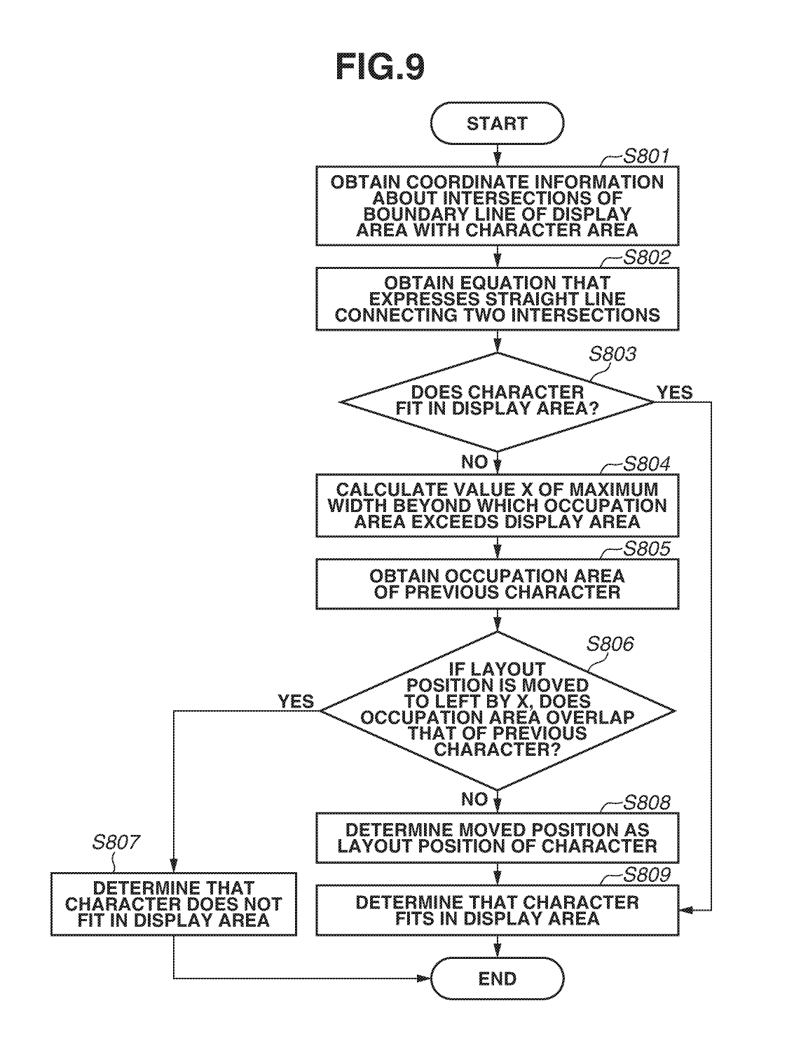

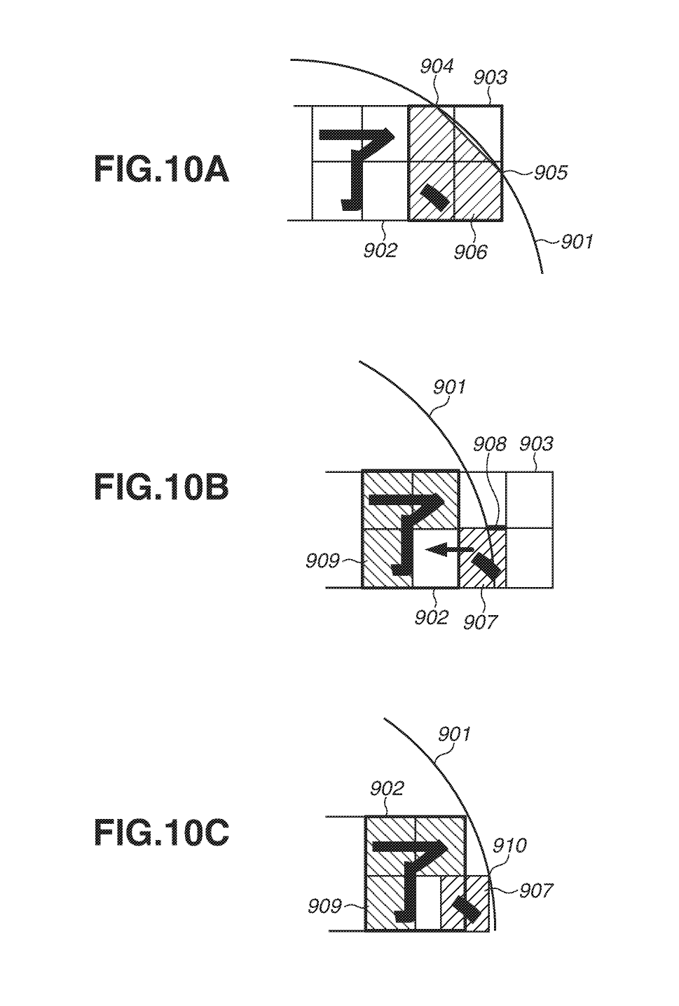

An example of the determination method of the occupation area determination unit 208 will be described with reference to the flowchart of FIG. 9 and FIGS. 10A to 10C. FIG. 10A is a diagram illustrating a state where character areas up to a character area 902 of a character “ [symbol] ” have been already determined to fit in a display area 901, and it is determined that a character area 903 of a character “, ” does not fit in the display area 901.

In step S801, the occupation area determination unit 208 obtains coordinate information about intersections 904 and 905 of the boundary line of the display area 901 and the character area 903.

In step S802, the occupation area determination unit 208 obtains an equation that represents a straight line connecting the two intersections. A hatched area 906 surrounded by the straight line connecting the two intersections, and the boundary lines of the character area 903 approximates the area included in the display area 901.

In step S803, the occupation area determination unit 208 determines whether the occupation area 706 of the character “, ” illustrated in FIG. 7B fits in the area 906. If the occupation area 706 of the character “, ” is on an inner side of the display area 901 relative to the straight line connecting the two intersections (YES in step S803), then in step S809, the occupation area determination unit 208 determines that the character “, ” fits in the display area 901. The processing of the flowchart of FIG. 9 ends.

A case where in step S803 it is determined that the occupation area does not fit in the display area 901 will be described with reference to FIG. 10B. FIG. 10B illustrates a state where a hatched occupation area 907 of a character “, ” overlaps the boundary line of the display area 901. In step S804, the occupation area determination unit 208 calculates a value X of a maximum width 908 by which the occupation area 907 exceeds the display area 901. This width is synonymous with a length.

In step S805, the occupation area determination unit 208 obtains a hatched occupation area 909 of a character “ [symbol] ” immediately previous to the character “, ”.

In step S806, the occupation area determination unit 208 determines, based on the occupation area 909 of the character “ [symbol] ”, whether the occupation area 907 and the occupation area 909 overlap when the layout position of the character “, ” is moved to the left by the value X of the maximum width 908. If it is determined that the occupation areas 907 and 909 overlap with each other (YES in step S806), the processing proceeds to step S807.

In step S807, the occupation area determination unit 208 determines that the character “, ” does not fit in the display area 901. The processing of the flowchart of FIG. 9 ends. If it is determined that the occupation areas 907 and 909 do not overlap with each other (NO in step S807), the processing proceeds to step S808.

In step S808, the occupation area determination unit 208 moves the occupation area 907 to the left by the value X as illustrated in FIG. 10C. The occupation area determination unit 208 then determines the resulting position as the layout position of the character “ [symbol] ”.

In step S809, the occupation area determination unit 208 determines that the character “ [symbol] ” fits in the display area 901 and the processing of the flowchart of FIG. 9 ends.

In the first exemplary embodiment, the processing for laying out an end-of-line character in the display area of circular shape has been described in a case where the end-of-line character is a special character having an occupation area on the left side of its character area, like Japanese punctuation marks. However, the CPU 101 may store information about the occupation areas of all the characters stored in the font data in the ROM 102 in advance and perform the processing on all the characters, not just symbols such as punctuation marks. The processing has been described by using character strings displayed from left to right like western languages. However, the same algorithm can be applied to character strings displayed from right to left like Arabic and ones displayed from top to bottom like Japanese, with only a difference in the changing direction of the layout position of a character.

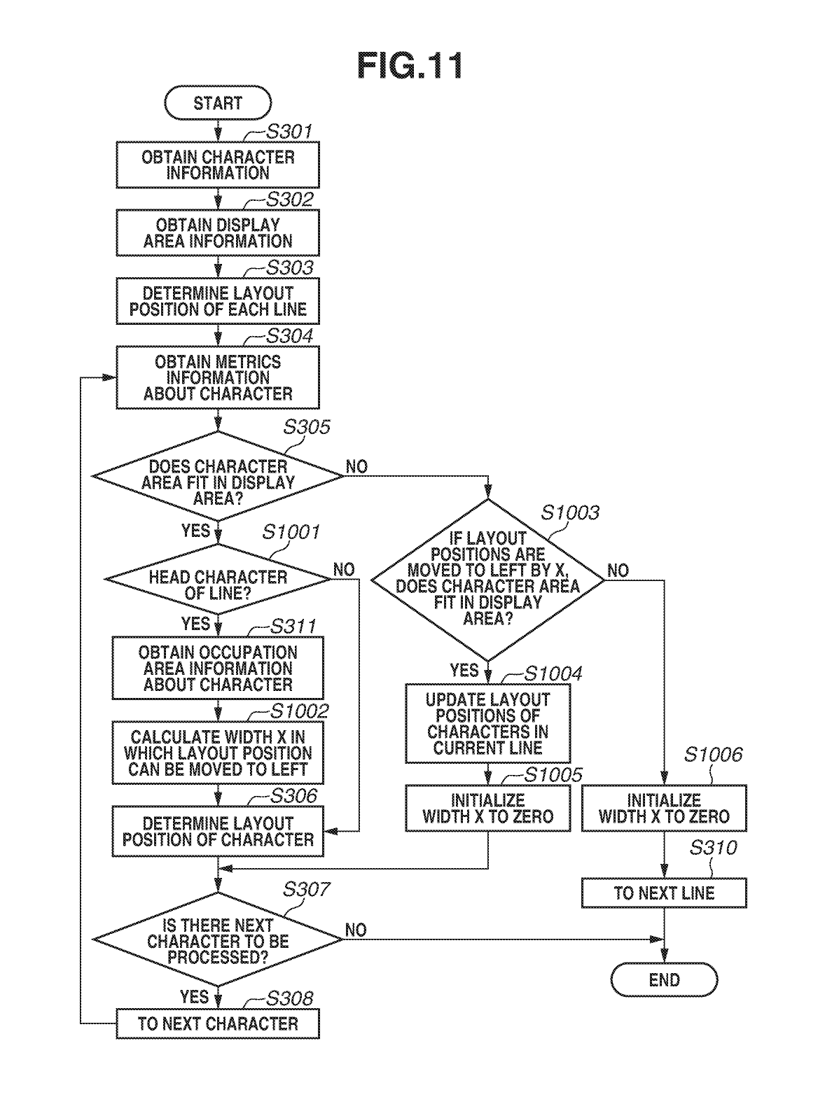

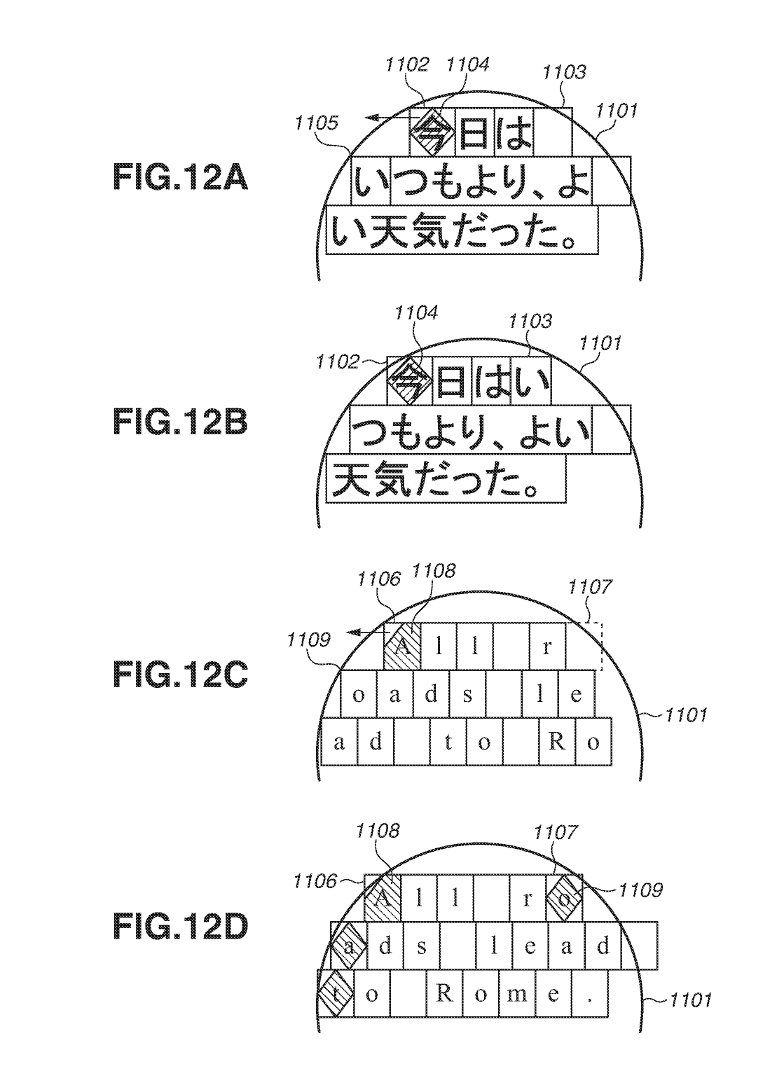

In a second exemplary embodiment, an example of character layout processing near the boundary of the display area at the beginning of a line when a character string is displayed as though it were poured into the display unit 106 of circular shape will be described according to the flowchart illustrated in FIG. 11 and with reference to FIGS. 12A to 12D.

FIG. 12A is a diagram illustrating a state where a Japanese character string is laid out as though it were poured into a display area 1101 of circular shape according to the flowchart of FIG. 3 described in the first exemplary embodiment. A start position is determined so that a character area 1102 of the head character “ [symbol] ” does not exceed the display area 1101. It is determined that the characters up to the end-of-line character “ [symbol] ” of the first line are determined to fit in the display area 1101. It is determined that a character area 1103 of the next character “ [symbol] ” does not fit in the display area 1101 and is thus laid out at a head position 1105 in the next line. Depending on the positions of a hatched occupation area 1104 of the head character “ [symbol] ” and the boundary line of the display area 1101, the layout positions of all the characters in the first line may be moved to the left without the occupation area 1104 exceeding the display area 1101.

Similarly, FIG. 12C illustrates a state where an alphabetic character string is laid out as though it were poured into the display area 1101 of circular shape according to the flowchart of FIG. 3. Layout positions are determined so that a character area 1106 of the head character “A” does not exceed the display area 1101. It is determined that the characters up to the end-of-line character “r” of the first line fit in the display area 1101. It is determined that a character area 1107 of the next character “o” does not fit in the display area 1101 and is thus laid out at a head position 1109 in the next line. Depending on the positions of a hatched occupation area 1108 of the head character “A” and the boundary line of the display area 1101, the layout positions of all the characters in the first line may be moved to the left without the occupation area 1108 exceeding the display area 1101.

The processing of the flowchart illustrated in FIG. 11 is an example of information processing for determining whether the occupation area of the head character of each line exceeds the display area, and if not, moving the layout positions of all the characters in that line to the left.

The processing of steps S301 to S305 in FIG. 11 is similar to that of FIG. 3. A description thereof will thus be omitted. If, in step S305, it is determined that the character area fits in the display area (YES in step S305), then in step S1001, the character area determination unit 205 determines whether the character in process is the head character of the line. The processing of step S1001 is an example of processing for determining whether the character to be processed is a head character of a line or column. If the character in process is determined to not be the head character (NO in step S1001), the processing proceeds to step S306. In step S306, the character layout position determination unit 206 determines the layout position. If there is a next character (YES in step S307), then in step S308, the character layout position determination unit 206 shifts the processing to the next character. On the other hand, if it is determined that the character in process is the head character (YES in step S1001), the processing proceeds to step S311. In step S311, the occupation area information acquisition unit 207 obtains the occupation area information about the letter form.

In step S1002, the occupation area determination unit 208 calculates a width X by which the layout position can be moved to the left without the occupation area exceeding the display area, based on the obtained occupation area information and the display area information obtained in step S302. The occupation area determination unit 208 stores the value of the width X. A method for calculating the width X will be described below. The calculation of the width X is an example of derivation of the width X. The width X will not be referred to in the processing of step S306. In step S307, if the character layout position determination unit 206 determines that there is no next character (NO in step S307), the processing of the flowchart illustrated in FIG. 11 ends. If there is a next character (YES in step S307), then in step S308, the character layout position determination unit 206 shifts the processing to the next character. In the processing of step S305, if it is determined that the character area does not fit in the display area (NO in step S305), the processing proceeds to step S1003. As employed herein, the left is an example of a direction which is set. The left is set if the character string is displayed from left to right. For example, if the character string is displayed from right to left, the right is set. In other words, the set direction is right. For example, if the character string is displayed from top to bottom, the top is set. That is, the set direction is up. The layout position of the head character is changed in a direction such that the head character approaches the end of the display area.

As another method for determining the width X, the leftmost pixel of each drawing stroke of the head character may be detected to calculate a distance from the pixel position to the boundary line of the display area.

In step S1003, the character area determination unit 205 determines whether the character area fits in the display area when the characters of which the layout positions have already been determined in the current line, are moved to the left by the width X as a whole. If it is determined that the character area fits in the display area (YES in step S1003), the processing proceeds to step S1004. The processing of step S1003 is an example of processing for determining whether the character area of the process target character fits in the display area of the display unit when the characters of which the layout positions have already been determined in the current line or column, are moved in the foregoing direction by the width X.

In step S1004, when the layout positions of the characters is already determined in the current line, the character layout position determination unit 206 updates the layout positions of the respective characters, which are moved to the left by the width X.

In step S1005, the character area determination unit 205 initializes the width X to zero. In step S308, the character layout position determination unit 206 shifts the processing to the next character.

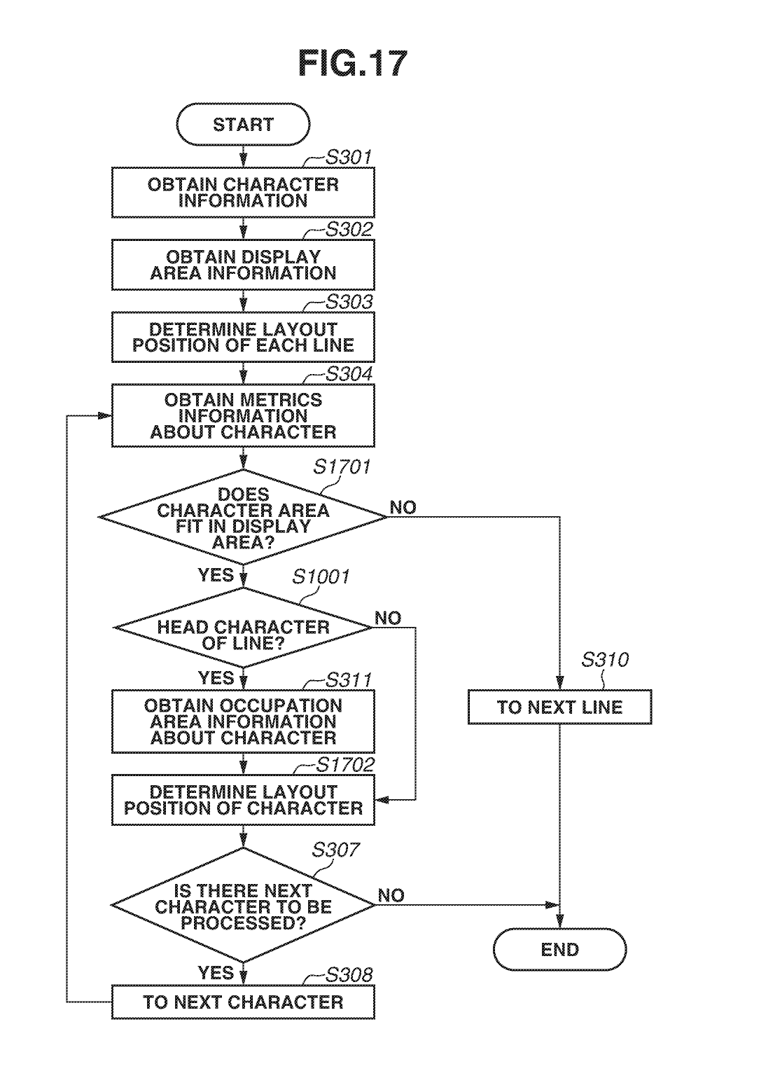

The processing of step S1003 is an example of processing for determining whether the character area of the character to be processed fits in the display area of the display unit (i.e., determining whether a character in the next line fits in the current line) when the characters of which the layout positions have already been determined in the current line or column, are shifted in the foregoing direction by the width X. However, the head character of a line may be moved in the foregoing direction regardless of whether the character in the next line fits in the current line. In such a case, the character layout position determination unit 206 finds a length by which the layout position of the head character can be changed within a range in which the letter form of the head character does not exceed the display area, and adjusts the layout position based on the length. An example of such a processing flow will be described with reference to FIG. 17.

The processing of steps S301 to S304 is similar to that of FIG. 11. A description thereof will thus be omitted. In the processing of step S1701, if it is determined that the character area does not fit in the display area (NO in step S1701), the processing proceeds to step S310. On the other hand, if it is determined that the character area fits in the display area (YES in step S1701), the processing proceeds to step S1001. In step S1001, if it is determined that the character in process is the head character of the line (YES in step S1001), then in step S311, the occupation area information acquisition unit 207 obtains the occupation area information about the letter form. In step S1702, the character layout position determination unit 206 determines the layout position of the character which is shifted to the left so that the occupation area fits in the display area. On the other hand, if it is determined that the character in process is not the head character of the line (NO in step S1001), then in step S1702, the character layout position determination unit 206 determines the layout position of the character based on the character area. The subsequent processing is similar to that of FIG. 11. A description thereof will thus be omitted.

FIG. 12B illustrates a state where layout positions are moved to the left in a leftward movement width X which is calculated in step S1002 based on the occupation area 1104 of the head character “ [symbol] ” in the state illustrated in FIG. 12A. Since the layout positions of the first to third characters are each moved to the left, the character area 1103 of the fourth character “ [symbol] ” fits in the display area 1101. In step S1003, if it is determined that the character area does not fit in (NO in step S1003), the processing proceeds to step S1006. In step S1006, the character layout position determination unit 206 resets the width X to zero without updating the layout positions. In step S310, the character layout position determination unit 206 shifts the processing to the next line, ending the processing of the current line.

FIG. 12D illustrates a state where the layout position of the entire first line is moved to the left in the movement width X obtained in step S1002 based on the occupation area 1106 of the head character “A” in the state illustrated in FIG. 12C. The layout positions of the first to fifth characters are each moved to the left. While the character area 1107 of the sixth character “o” does not fit in the display area 1101, it is determined that a hatched occupation area 1110 of the sixth character “o” fits in the display area 1101 if the layout processing for an end-of-line character described in the first exemplary embodiment is performed. Similar processing is performed on the subsequent lines. Depending on the positions of the occupation area of the head character of a line and the boundary line of the display area 1101, the layout position of the entire line can be moved to the left. Margins near the boundary of the display area 1101 at the ends of lines can also be effectively used by the method described in the first exemplary embodiment.

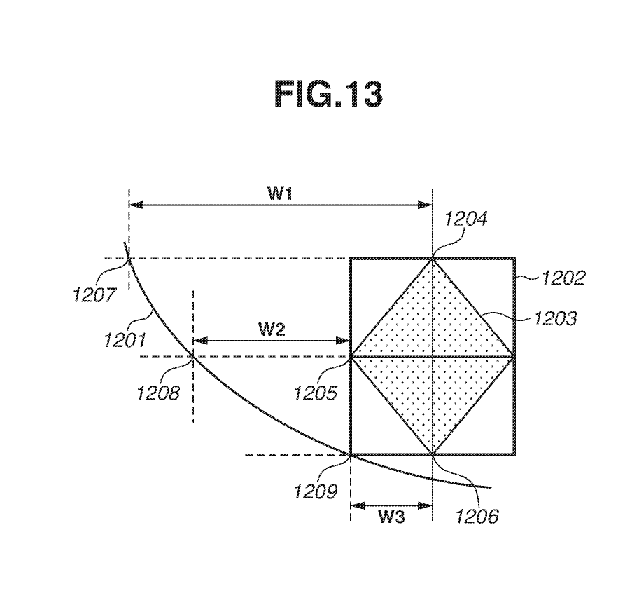

An example of the method for calculating the width X of possible movement to the left in step S1002 will be described with reference to FIG. 13. The layout position of a line of a character string is determined inside a boundary line 1201 of the display area of circular shape, and a character area 1202 of the head character is laid out. Such a state represents the state of step S1001 in the flowchart of FIG. 11. In the present exemplary embodiment, the character area 1202 is divided into eight triangular areas like the occupation area 707 of the character “ [symbol] ” illustrated in FIG. 7B. A sum set of triangular areas including a letter form is defined as an occupation area. The shape and the number of areas into which the character area is divided to define an occupation area are not limited thereto. Here, a shaded area 1203 serves as the occupation area of the head character.

The occupation area determination unit 208 obtains the y coordinates of vertexes of the occupation area 1203. The values of the y coordinates to be obtained are those of vertexes 1204, 1205, and 1206. Horizontal lines passing through the respective y coordinates form intersections 1207, 1208, and 1209 with the boundary line 1201. Since the display area is circular in shape, the occupation area determination unit 208 can determine the coordinates of the intersections 1207, 1208, and 1209 by using a function representing the circle. The horizontal lines each have two intersections. A horizontal line forms only one intersection if the horizontal line is a tangent to the circle. However, to include the character area within the circle, the horizontal lines always have two intersections each. The width from the vertex 1204 to the intersection 1207 will be denoted by W1. The width from the vertex 1205 to the intersection 1208 will be denoted by W2. The width from the vertex 1206 to the intersection 1209 will be denoted by W3. The occupation area determination unit 208 determines the minimum value of width among W1, W2, and W3 as the value of the width X. In FIG. 13, the width X is W3. While the display area in the present exemplary embodiment is circular in shape, the display area may have the shape of an arbitrary convex closed curve. In such a case, the occupation area determination unit 208 makes linear approximations on the curve and divides the curve into a plurality of straight lines. The occupation area determination unit 208 then determines the intersections of the horizontal lines passing through the y coordinates of the vertexes of the occupation area and the straight lines obtained by the approximation. The occupation area determination unit 208 can thus determine the value of the width X as in the present exemplary embodiment.

In the second exemplary embodiment, an example of the method for determining the width in which the head character can be moved to the left based on the occupation area, and changing the layout positions of characters according to the width, has been described. Alternatively, specific characters may be registered in advance as ones that can be moved to the left. If the head character of a line corresponds to one of the specific registered characters, the character layout position determination unit 206 performs processing for changing the layout position of the character based on information about the movable width. If the head character does not correspond to any of the specific characters, the character layout position determination unit 206 does not change the layout position of the character. In step S1001 of FIG. 11, the processing branches depending on whether the head character of the line is a specific character.

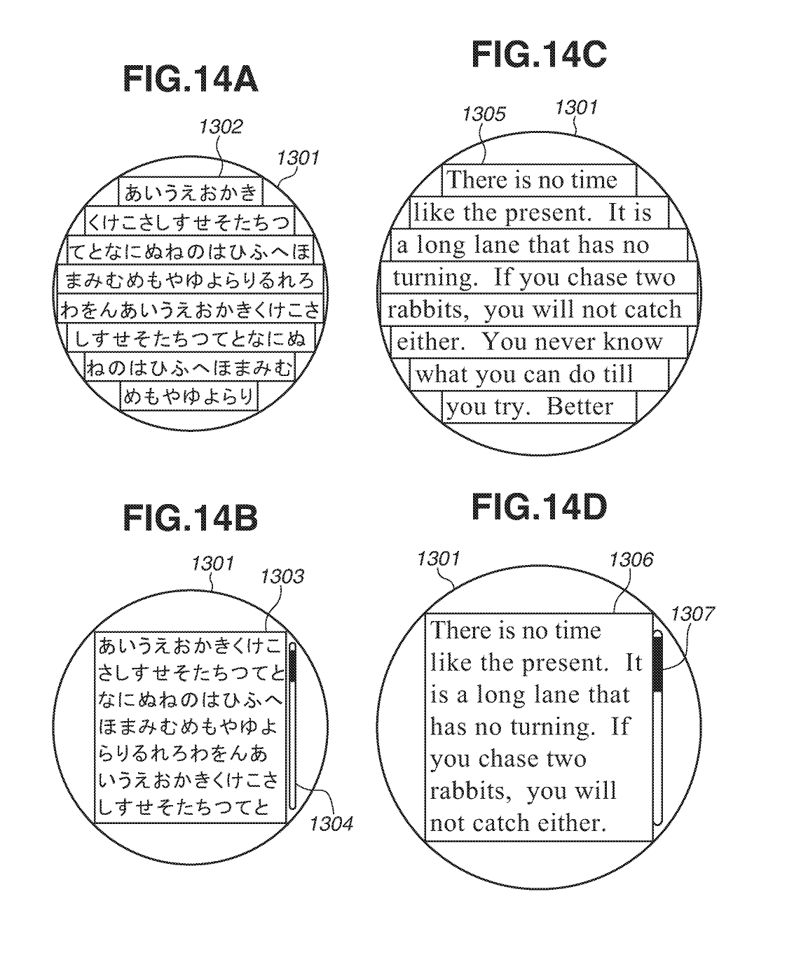

In a third exemplary embodiment, a method for switching the shape of the display area depending on whether an entire character string laid out like being poured into the display unit 106 of circular shape fits in the display area will be described with reference to FIGS. 14A to 14D. FIGS. 14A and 14C each illustrate a state where a character string is poured into a display area 1301 of circular shape and the characters are laid out by using at least either one of the character layout methods according to the first and second exemplary embodiments. FIG. 14A illustrates a case where the input character string is in Japanese. FIG. 14C illustrates a case where the input character string is in alphabet letters of the English language. A rectangle 1302 and a rectangle 1305 represent rectangles where the character areas of characters in respective first lines fit in. Rectangles where the character areas of subsequent lines fit in are similarly illustrated without a reference numeral. If an entire character string fits in the display area 1301, the layout positions of the respective characters are determined and the character string is displayed.

If the input character strings in FIGS. 14A and 14C does not fit in the display area 1301, a scroll bar is typically displayed in the display area 1301. The user can operate the scroll bar by touch operations and display the character strings. However, since the display area is circular in shape, the rectangles where the character areas fit in such as the rectangles 1302 and 1305, differ in size between each line. If the character strings are vertically scrolled from the state of FIG. 14A or 14C, characters having fitted in one line do not always fit in another line, and the complicated character layout processing needs to be performed again. In scroll operations, animation needs be displayed at high speed.

For example, when it is determined that a character string does not fit in the display area 1301, the character layout position determination unit 206 switches to a new display area such as a rectangle 1303 and a rectangle 1306 which fit in the display area 1301 as illustrated in FIGS. 14B and 14D. Since it is known that the character string does not fit in the display area 1301, the character string may be laid out in the rectangle 1303 or 1306 without the layout processing as in the first and second exemplary embodiments, but so that the character areas of characters fit in the rectangle 1303 or 1306. For the purpose of scroll processing by the user's touch operations, for example, the character layout position determination unit 206 may lay out a scroll bar 1304 or 1307 beside the new display area. Since the circular display area is changed to a rectangular one and the character layout processing is simplified, scroll display of higher response can be carried out. The information processing apparatus 100 displays the scroll bar 1304 or 1307 near the rectangle 1303 or 1306 that is the new display area (within a predetermined range from the rectangle 1303 or 1306).

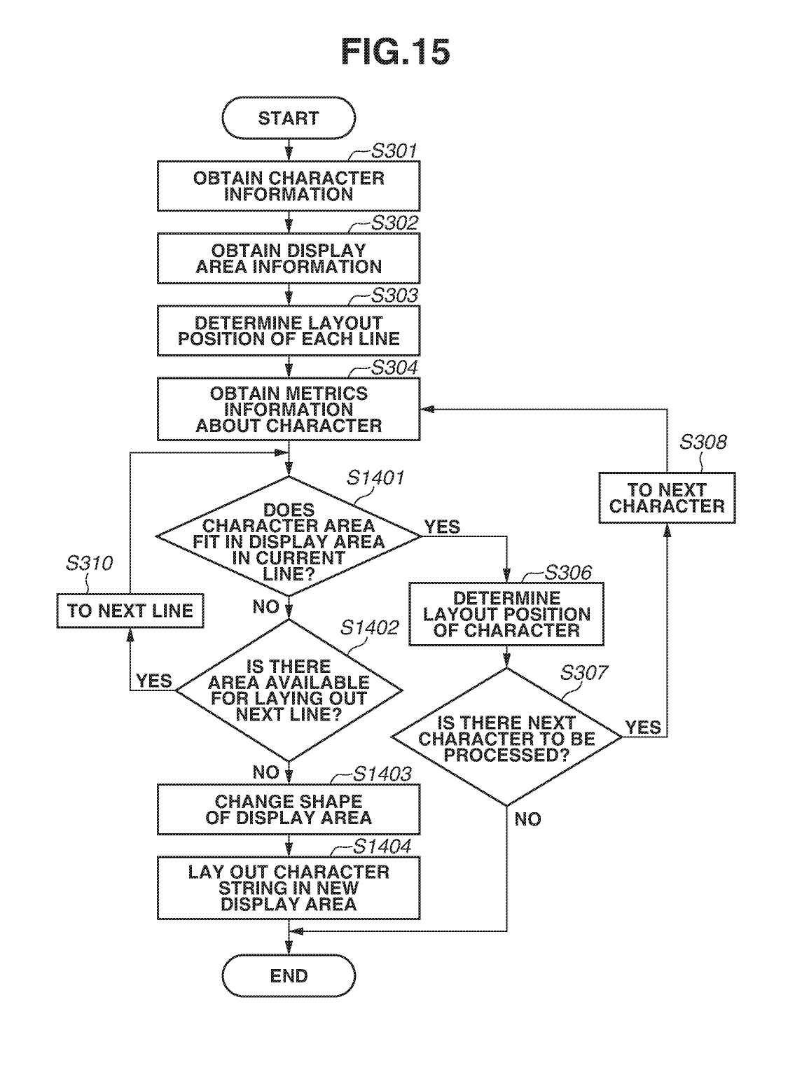

An example of such information processing related to the changing of the display area will be described with reference to the flowchart illustrated in FIG. 15. A description of steps denoted by the same reference numerals as FIG. 3 will be omitted. After the acquisition of character string information to be laid out and display area information, the layout position of each line is determined.

Metrics information about the characters is obtained in order from the head character. In step S1401, the character area determination unit 205 determines whether the character area fits in the display area 1301 in the current line. If the character in process is a specific character at the end of the line, the information processing apparatus 100 may perform the character layout processing described in the first exemplary embodiment. If the character in process is the head character of the line, the information processing apparatus 100 may perform the character layout processing described in the second exemplary embodiment. In step S1401, if it is determined that the character area fits in the display area 1301 (YES in step S1401), the processing proceeds to step S306.

In step S306, the character layout position determination unit 206 determines the layout position of the character. If there is no next character (NO in step S307), the processing of the flowchart illustrated in FIG. 15 ends. If there is a next character (YES in step S307), then in step S308, the character layout position determination unit 206 shifts the processing to the next character.

In step S1401, if it is determined that the character area does not fit in the display area (NO in step S1401), the processing proceeds to step S1402.

In step S1402, the character area determination unit 205 determines whether there is an area available for laying out a next line in the display area 1301. If it is determined that there is an area available for laying out a next line (YES in step S1402), the processing proceeds to step S310.

In step S310, the character layout position determination unit 206 shifts to the head character of the next line and the processing proceeds to step S1401. On the other hand, if it is determined that there is no area available for laying out a next line (NO in step S1402), the processing proceeds to step S1403.

In step S1403, the character layout position determination unit 206 discards information about the already-determined layout positions of characters, and changes the shape of the display area. The shape and size of the changed display area are not particularly limited. In the present exemplary embodiment, for the sake of simplification of the character layout processing, the character layout position determination unit 206 changes the shape of the display area to a square, such as the rectangle 1303 of FIG. 14B, which has the maximum area among rectangles included in the display area 1301. If the display area 1301 is a circle having a radius of R, the square has a side of R√2.

In step S1404, the character layout position determination unit 206 lays out the character string again in the rectangle 1303. The character layout position determination unit 206 lays out the character areas of the characters as if paved rightward in order from the top left of the rectangle 1303. If the character areas no longer fit in the line, the character layout position determination unit 206 shifts the processing to the next line. In such a manner, the character layout position determination unit 206 repeats the layout processing until no more characters fit in the rectangle 1303.

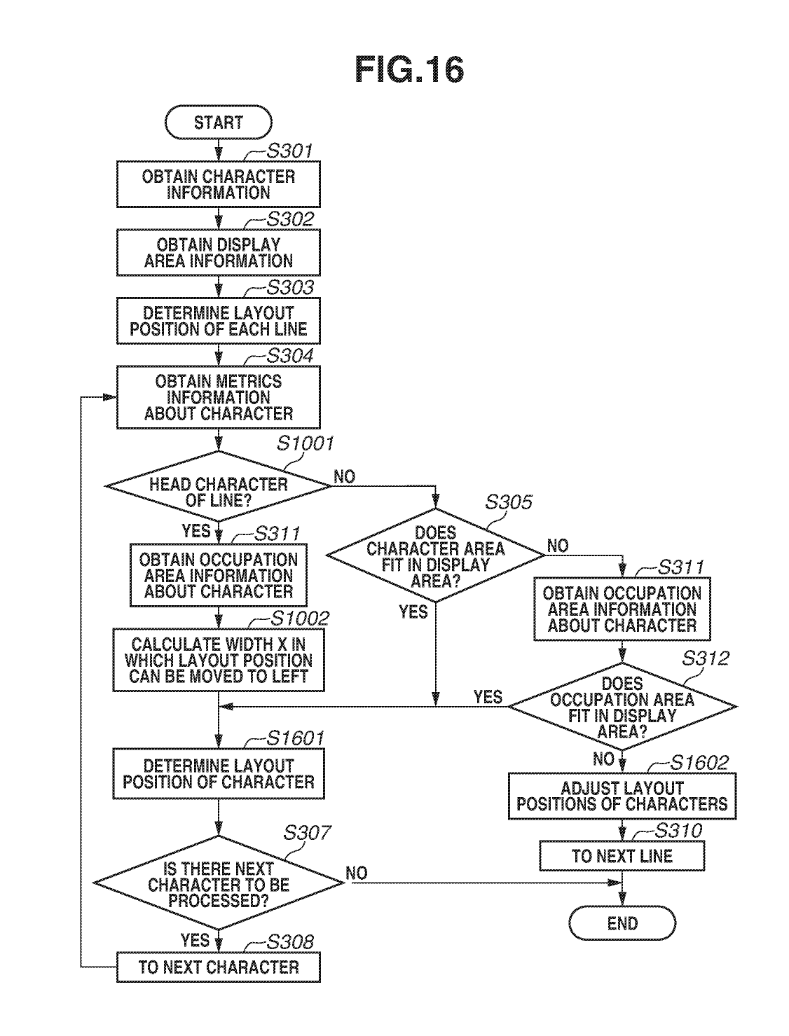

In the second exemplary embodiment, an example of the information processing has been described in which the start position is moved to the left based on the occupation area of the head character if the character area of the end-of-line character of that line does not fit in the display area. In the present exemplary embodiment, the head character of a line is laid out close up to the left boundary so that the occupation area fits in the display area, regardless of whether the end-of-line character fits in. If there is a margin on the right after characters are laid out up to the end character of the line, the layout positions are adjusted so that the character string comes to the center of the area where the lay-out is possible. An example of such information processing will be described with reference to FIG. 16. A detailed description of steps denoted by the same reference numerals as used in the foregoing will be omitted.

The processing up to step S304 of FIG. 16 is similar to that of FIG. 3. A description thereof will thus be omitted.

In step S1001, the character area determination unit 205 determines whether the character is the head character of the line. If it is determined that the character is the head character (YES in step S1001), the processing proceeds to step S311. In step S311, the occupation area information acquisition unit 207 obtains the occupation area information. In step S1002, the occupation area determination unit 208 calculates the width X in which the layout position can be further moved to the left from the start position where the character area fits in the display area, based on a positional relationship between the boundary line of the display area, and the occupation area. The calculation of the width X is an example of the derivation of the width X.

In step S1601, the character layout position determination unit 206 determines the layout position of the character from the calculated width X. In step S1001, if it is determined that the character is not the head character (NO in step S1001), the processing proceeds to step S305. In step S305, the character area determination unit 205 determines whether the character area fits in the display area. If it is determined that the character area fits in the display area (YES in step S305), the processing proceeds to step S1601. If it is determined that the character area does not fit in the display area (NO in step S305), the processing proceeds to step S311. In step S311, the occupation area information acquisition unit 207 obtains the occupation area information. In step S312, the occupation area determination unit 208 determines whether the occupation area fits in the display area. If it is determined that the occupation area fits in the display area (YES in step S312), the processing proceeds to step S1601. If it is determined that the occupation area does not fit in the display area (NO in step S312), the processing proceeds to step S1602.

In step S1602, the character layout position determination unit 206 adjusts the layout positions of the characters. The character layout position determination unit 206 determines a width T by subtracting the x coordinate of the right end of the character area related to the immediately previous character from the x coordinate of the boundary line of the display area closer to the end character of the line. If the width T is smaller than or equal to a predetermined threshold, the character layout position determination unit 206 moves the layout position of the entire character string in that line to the right by T/2. The processing of step S1602 is an example of processing for adjusting the already determined layout positions of characters in the current line or column to move in a direction opposite from step S1002 if it is determined that the occupation area does not fit in the display area.

### Other Exemplary Embodiments

An exemplary embodiment of the present invention may be realized by supplying a program for implementing one or more functions of the foregoing exemplary embodiments to a system or an apparatus via a network or a recording medium, and reading and executing the program by one or more processors of a computer in the system or apparatus. An exemplary embodiment of the present invention may be realized by using a circuit (for example, an application specific integrated circuit (ASIC)) that implements one or more of the functions.

The exemplary embodiments of the present invention have been described in detail above. However, the present invention is not limited to such specific exemplary embodiments. For example, the software configuration illustrated in FIG. 2 described above may be implemented on the information processing apparatus 100 as a hardware configuration. In such a case, arithmetic units and circuits corresponding to the respective units of FIG. 2 may be implemented on the information processing apparatus 100. According to the descriptions of the foregoing exemplary embodiments, the processing is performed by one information processing apparatus 100. However, a plurality of computers may perform the processing in a distributed manner to provide the foregoing functions of the information processing apparatus 100. According to the descriptions of the foregoing exemplary embodiments, the data that the CPU 101 uses in executing processing such as the table information, is stored in the ROM 102. However, the data may be stored in another apparatus that can communicate with the information processing apparatus 100 via a network. The foregoing exemplary embodiments may be carried out in any combination.

As described above, according to the processing of the foregoing exemplary embodiments, the limited display area of the display unit 106 can be effectively used for character display.

According to an exemplary embodiment of the present invention, a limited display area can be effectively used for character display.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-197791, filed Oct. 5, 2015, which is hereby incorporated by reference herein in its entirety.

What is claimed is:

1. An information processing apparatus comprising:
a derivation unit configured to derive a length by which a position of a head character laid out at a beginning of a line or column of characters displayed in a display area of a display unit can be changed within a range in which a letter form of the head character does not exceed the display area; and
an adjustment unit configured to adjust the layout position of the head character and that of a character subsequent to the head character based on the length.

2. The information processing apparatus according to claim 1, wherein the derivation unit is configured to derive the length within a range in which a pixel of the head character does not exceed the display area.

3. The information processing apparatus according to claim 1, wherein the derivation unit is configured to derive the length by which the layout position can be changed in a direction in which the head character approaches an end of the display area, and
wherein the adjustment unit is configured to adjust the layout positions of the head character and the character subsequent to the head character, in the direction, based on the length.

4. The information processing apparatus according to claim 1, further comprising an acquisition unit configured to acquire occupation area information about the head character,
wherein the derivation unit is configured to derive the length by which the layout position of the head character can be changed within a range in which an occupation area of the head character does not exceed the display area, based on the occupation area information.

5. The information processing apparatus according to claim 4, wherein the acquisition unit is configured to acquire a sum set of areas in which a shape of a character is included, among areas into which a character area of the character is divided, as occupation area information about the character.

6. The information processing apparatus according to claim 1, wherein, if a head character of a second line or column not fitting in the same first line or column as the head character before the layout position of the head character is changed, fits in the first line or column when the layout positions of the head character and the character subsequent to the head character are adjusted by the length, the adjustment unit is configured to adjust the layout positions of the head character and the character subsequent to the head character based on the length, so that the head character of the second line or column fits in the first line or column.

7. The information processing apparatus according to claim 1, wherein, if a head character of a second line or column not fitting in the same first line or column as the head character before the layout position of the head character is changed, does not fit in the first line or column when the layout positions of the head character and the character subsequent to the head character are adjusted by the length, the adjustment unit is configured to not adjust the layout position of the head character or the character subsequent to the head character.

8. The information processing apparatus according to claim 1, further comprising:
a determination unit configured to determine whether an entire character string fits in the display area of the display unit;
a change unit configured to, if the determination unit determines that the entire character string does not fit in the display area of the display unit, change a shape of the display area; and
a layout unit configured to lay out characters of the character string in the display area of the shape changed by the change unit.

9. The information processing apparatus according to claim 8, wherein the change unit is configured to, if the determination unit determines that the entire character string does not fit in the display area of the display unit, change the shape of the display area to a rectangle included in the display area, the rectangle having a maximum area, and lay out a scroll bar near the display area.

10. An information processing apparatus comprising:
an acquisition unit configured to acquire letter form information about a character; and
an adjustment unit configured to, if a specific character is laid out at a beginning of a line or column of characters displayed in a display area of a display unit, adjust a layout position of the specific character by a length within a range in which a letter form of the specific character does not exceed the display area based on letter form information about the specific character acquired by the acquisition unit, and if a character other than a specific character is laid out at the beginning, not adjust the layout position of the character laid out at the beginning.

11. The information processing apparatus according to claim 10, wherein the adjustment unit is configured to adjust the layout position of the specific character by a length within a range in which a pixel of the specific character does not exceed the display area.

12. The information processing apparatus according to claim 10, wherein the adjustment unit is configured to adjust the layout position in a direction in which the specific character approaches an end of the display area.

13. The information processing apparatus according to claim 10, further comprising:
a determination unit configured to determine whether an entire character string fits in the display area of the display unit;
a change unit configured to, if the determination unit determines that the entire character string does not fit in the display area of the display unit, change a shape of the display area; and
a layout unit configured to lay out characters of the character string in the display area of the shape changed by the change unit.

14. The information processing apparatus according to claim 13, wherein the change unit is configured to, if the determination unit determines that the entire character string does not fit in the display area of the display unit, change the shape of the display area to a rectangle included in the display area, the rectangle having a maximum area, and lay out a scroll bar near the display area.

15. An information processing apparatus comprising:
an acquisition unit configured to, if a character area of a process target character among characters included in a character string displayed in a display area of a display unit, does not fit in the same line or column in the display area as a character immediately previous to the character to be processed, obtain occupation area information about the process target character; and
a determination unit configured to, if an occupation area indicated by the occupation area information acquired by the acquisition unit fits in the display area, determine that a layout position of the process target character comes at a position in the same line or column as the character immediately previous to the process target character, and located after the character immediately previous to the process target character.

16. An information processing method comprising:
deriving a length by which a layout position of a head character laid out at a beginning of a line or column of characters displayed in a display area of a display unit can be changed within a range in which a letter form of the head character does not exceed the display area; and
adjusting the layout position of the head character and that of a character subsequent to the head character based on the length.

17. An information processing apparatus comprising:
obtaining letter form information about a character; and
if a specific character is laid out at a beginning of a line or column of characters displayed in a display area of a display unit, adjusting a layout position of the specific character by a length within a range in which a letter form of the specific character does not exceed the display area based on letter form information about the specific character acquired by the acquiring, and if a character other than a specific character is laid out at the beginning, not adjusting the layout position of the character laid out at the beginning.

18. An information processing method comprising:
if a character area of a process target character among characters included in a character string displayed in a display area of a display unit, does not fit in the same line or column in the display area as a character immediately previous to the process target character, acquiring occupation area information about the process target character; and
if an occupation area indicated by the occupation area information acquired by the acquiring fits in the display area, determining that a layout position of the process target character comes at a position in the same line or column as the character immediately previous to the process target character, and located after the character immediately previous to the process target character.

19. A non-transitory computer-readable storage medium storing therein a program for causing a computer to perform the method according to claim 16.

20. A non-transitory computer-readable storage medium storing therein a program for causing a computer to perform the method according to claim 17.

21. A non-transitory computer-readable storage medium storing therein a program for causing a computer to perform the method according to claim 18.
